(19) United States
(12) Patent Application Publication
(10) Pub. No.: US 2025/0276330 A1
(43) Pub. Date: Sep. 4, 2025

(54) VANADIUM RECOVERY

(71) Applicant: Australian Vanadium Limited, West Perth (AU)

(72) Inventors: Todd RICHARDSON, Forrestfield (AU); Brian Alexander McNab, Como (AU); Sai Wei LAM, Aubin Grove (AU)

(21) Appl. No.: 18/285,701

(22) PCT Filed: Apr. 8, 2022
(86) PCT No.: PCT/AU2022/050315

§ 371 Date: Oct. 5, 2023

(30) Foreign Application Priority Data
Apr. 9, 2021 (AU) 2021901042

(51) Int. Cl. B03D 1/004; C22B 1/02; C22B 3/04; C22B 3/22; C22B 34/12; C22B 34/22

(52) U.S. Cl. CPC B03D 1/0046; C22B 1/02; C22B 3/04; C22B 3/22; C22B 34/12; C22B 34/22; B03D 2201/02; B03D 2203/04

(57) ABSTRACT

A method for the recovery of vanadium, the method including the steps of:
(i) subjecting a vanadium-containing ore to a beneficiation step incorporating a sequence of medium-intensity magnetic separation, high-intensity magnetic separation and reverse silica flotation processes to form a vanadium-containing concentrate;
(ii) roasting the vanadium-containing concentrate;
(iii) leaching a product of the roasting step (ii) to extract vanadium into a pregnant leach liquor;
(iv) passing the pregnant leach liquor of leaching step (iii) to a precipitation step; and
(v) Treating a precipitate from step (iv) to obtain a vanadium product,
   wherein an iron-titanium product from step (iii) is recovered.

### FIELD OF THE INVENTION

The present invention relates to a method for the recovery of vanadium from vanadium bearing ores or concentrates.

More particularly, the vanadium bearing ore or concentrate may be a vanadium bearing titanomagnetite ore.

In one form the present invention further provides for the preparation of by-products that may include a titanium-containing iron oxide or either or both of a titanium iron containing by-product.

In a further form the present invention further provides for the cost effective and environmentally sustainable disposal of undesirable impurities from a vanadium bearing titanomagnetite ore.

### BACKGROUND ART

Although vanadium is a relatively minor constituent of the earth's crust, recent developments relating to its industrial applications have resulted in an increase in the activities that ensure reliable sources of vanadium-containing products are readily available in the immediate and near future. Current and projected uses include micro alloyed steels, vanadium redox flow batteries (VRFBs), and super-alloys for aerospace applications.

Despite the fact more than 50 individual vanadium-containing minerals are known, their occurrence in nature is very limited. The primary sources of vanadium are restricted to various host minerals where vanadium ions substitute for other ions at the molecular level within an appropriate host mineral structure. Typically, vanadium (III) substitutes for iron (III) in various iron oxides, especially magnetite, and to a lesser extent hematite, goethite and jarosite. Vanadium-containing titanomagnetite (VTM) is the primary commercial source of vanadium comprising over 85% of global supply.

Titanomagnetite deposits are often associated with ilmenite and rutile resources, are relatively common, with the latter forming the most significant feedstocks for the titanium industry. VTM deposits that can be exploited for vanadium production will typically have ore grades between 0.3 to 1.2% V₂O₅. As such, VTMs are classified as low-grade resources. These ores are commonly upgraded through beneficiation to produce a concentrate that can range from 1.0 to 3.2% V₂O₅.

Over 55% of current global vanadium production is generated as a by-product of pig iron production. VTM ores and concentrates are processed in specially designed blast furnaces where vanadium is separated from iron as a component of the slag phase. This slag is then refined into vanadium products using several different processing technologies.

Another 30% of current vanadium supply is produced directly from VTM concentrates utilising well-documented salt-roast leach technologies. Titanium and iron units are waste products with little realised economic value.

The remaining 15% of vanadium production is comprised almost entirely from secondary vanadium sources. Vanadium is generated as a by-product in uranium extraction from carnotite ores and in the refining of oil sands. Various petroleum cokes, or “pet-cokes”, also contain vanadium which is extracted from ashes and slags generated from its use. Other by-product sources include hard rock “stone” coal as well as vanadium bearing spent catalysts.

There is a considerable volume of literature available in the public domain relating to many aspects covering the production of high-purity vanadium pentoxide from a variety of vanadium-containing ores, concentrates and secondary resources. However, a significant proportion of this is of an academic nature focusing on one aspect, such as the leaching or physical beneficiation, rather than on a fully integrated continuous flowsheet. As a general comment, much of the reported data in the public domain relates to small-scale test work carried out on a relatively simple batch basis. Many of the proposed prior art process flowsheets based on the sparse data can be discarded as having little or no commercial and/or technical and/or environmental benefits. Little consideration is given to matters such as deportment and treatment of impurities, reagent consumption and recycling potential, energy requirements, waste stream management and the process water balance.

As a result of the inherent mineralogy of the run-of-mine feedstock, some form of upgrading by physical means ahead of downstream processing to recover the final vanadium pentoxide will typically be appropriate but are also technically challenging.

Generally, magnetic separation is used to upgrade VTM ores and reject silica. Silica rejection is of critical importance, because silica consumes reagents in the downstream roast process and renders a portion of vanadium insoluble. Low or medium intensity magnetic separation is traditionally used to reject silica, but this fails to recover weakly magnetic vanadium bearing minerals, such as hematite and goethite, which often form in the weathering profile above VMT fresh rock. A method that captured weakly-magnetic vanadium host minerals and rejected silica would be advantageous.

Having produced an upgraded feedstock, another challenge is to treat this material such that the vanadium content is converted into a water-soluble form from which the final product can be recovered, while the remaining components of the feedstock are converted into marketable by-products and/or disposed of in an environmentally sustainable form.

The mineralogical structure of the VTM phase is such that quite aggressive conditions are required to facilitate the formation of a vanadium-containing pregnant leach liquor from which high-purity vanadium pentoxide can be recovered.

Conventional direct hydrometallurgical leaching of VTM with, for example concentrated hydrochloric acid, sulphuric acid, or hydrofluoric acid at elevated temperatures, typically 110-220° C., have all been studied at the laboratory scale.

None of the proposed direct hydrometallurgical processes have achieved practical (commercial) status. There are several reasons for this including substantial engineering and operational challenges, as well as the fact that such processes have a low degree of selectivity, with excessive iron and other gangue mineral dissolution. This results in high capital and operating cost associated with purification of the vanadium-containing pregnant leach liquor.

The complexity of the direct leaching option is well-illustrated in the proposed flowsheet claimed in WO2011/143689 (2011) entitled “Method for the extraction and recovery of vanadium” in which VTM feedstock is leached in concentrated hydrochloric acid followed by solvent extraction to separate the solubilised iron and vanadium. The flowsheet was subsequently modified by incorporating a high-temperature reduction step ahead of leaching with acidified ferric chloride solution as claimed in WO2018/184067 (2018) entitled “A method for preparing a leach feed material”. Both claimed flowsheets are characterised by, for example, numerous unit stages, challenges with a sustainable process water balance, and high reagent consumption requirements. Neither of these flowsheets disclose any operating details relating to the production of a vanadium-containing product, such as vanadium pentoxide, from a clarified and purified vanadium-containing pregnant leach liquor.

Direct reduction of VTM to form metallic iron has also been proposed in the art. The operation of the reduction process is quite complex and may involve, for example, a further upfront pyrometallurgical step and/or direct acid leaching. These processes are energy intensive and their viability will depend upon integration with steel manufacture rather than production of high-quality vanadium pentoxide.

These high-temperature reduction processes are not the primary subject of the present invention. However, the present invention does, in one form, provide for the generation of a titanium-iron by-product with relatively low vanadium content that has the potential to add to the overall revenue of a project. The weight yield of this by-product accounts for close to 100% by weight of the original VTM concentrate. It forms the solid residue resulting from the weak alkaline leaching of the soluble vanadium from the salt-roast product. This by-product may be sold directly to an appropriate steel mill or may be upgraded by direct reduction in situations where a low-cost source of energy is locally available. The market value of the titanium-iron by-product may be enhanced by lowering the silica content of the feedstock, as included in the overall physical beneficiation stage of the flowsheet of one form of the present invention.

Compared with the direct acid or alkaline leaching approach, greater effort has been directed at using an upfront pyrometallurgical (roasting) step ahead of a suitable and relatively simple hydrometallurgical (leaching) circuit. Traditionally, roasting is carried out under mild oxidising conditions. Additives such as sodium and calcium salts, especially NaCl, NaHCO₃, Na₂CO₃, Na₂SO₄, CaO and CaF₂, are mixed with the feedstock to facilitate the ultimate formation of a water-soluble vanadium intermediate product.

Roasting of the feedstock and additive may be carried out in a suitably operated device such as a fluid bed roaster, a rotary kiln, a straight grate or a grate kiln, each of which is equipped with product cooling and off gas treatment systems. The operating temperature depends, to some extent, on the nature of the roasting device, the composition of the additive, and the characteristics of the VTM concentrate.

Various options are applicable to leaching the water-soluble vanadium from the cooled roaster product. Regrinding of the roaster product ahead of and during the leach step may be appropriate. As with most leaching operations, the use of several stages using either the con-current or the counter-current mode of operation could be used to maximise vanadium dissolution while also minimising impurity dissolution.

Salt roasting and leaching is not totally selective with respect to impurity dissolution and several stages of impurity removal are required, both before and after separation of the leach residue, which typically corresponds to the bulk of the roaster product. Of particular concern are soluble silica, chromium, iron, manganese and titanium. It follows that optimisation of the salt roasting stage should, in at least a preferred form, take into account simultaneous vanadium and impurity dissolution.

In view of the desire that the invention yield an ultra high purity vanadium pentoxide product, the flowsheet of the present invention incorporates, in one form, the use of appropriate nanofiltration and solvent extraction processes in series to simultaneously recover soluble vanadium from the pregnant leach solution (PLS) and remove soluble impurities ahead of recovering a suitable vanadium-containing solid product that is ultimately converted into high-purity vanadium pentoxide. Moreover, the use of the solvent extraction technology has the added advantages of increasing the overall recovery of soluble vanadium, increasing the vanadium concentration of the PLS, as well as increasing the actual vanadium leach kinetics.

One route for the production of vanadium pentoxide is to use ammonia/ammonium salt (hydroxide, chloride, sulphate, carbonate) to precipitate ammonium metavanadate (AMV) or ammonium polyvanadate (APV) from the clarified and filtered pregnant leach solution. This can be achieved by way of a carefully controlled precipitation step that may include consideration of pH, reagent addition rates, temperature, and residence time. After washing and filtration the AMV or APV precipitate can be calcined to yield the final product.

Given the significant iron and titanium contents of the run-of-mine ore, and more particularly of a physically beneficiated concentrate, it follows that the economic sustainability of the overall flowsheet will be enhanced if these two metals are recovered in a marketable form, either individually or in combination, rather than being discharged to tailings facilities with no positive economic value. To achieve this outcome, solubilised components including alkali metals may be removed in the leaching process.

An economically and environmentally sustainable treatment flowsheet is typically recommended for successful mineral processing operations. For hydrometallurgical flowsheets the process water balance is important and overall process raw water consumption should be minimised. This is a factor addressed, at least in part, by the present invention in one or more forms thereof.

The method of the present invention has as one object thereof to overcome substantially the abovementioned problems of the prior art, or to at least provide a useful alternative thereto.

Throughout the specification, unless the context requires otherwise, the word “comprise” or variations such as “comprises” or “comprising”, will be understood to imply the inclusion of a stated integer or group of integers but not the exclusion of any other integer or group of integers.

Throughout the specification, unless the context requires otherwise, the word “heap” or term “heap leach”, will be understood to include reference to a column or column leach.

Throughout the specification, unless the context requires otherwise, the term “ultra-high purity vanadium solution” is to be understood to designate a solution capable of yielding a V₂O₅ product of greater than 99.5% purity. Similarly, if reference is made to an “ultra-high purity product” in the context of the production of a vanadium product, it is to be understood to designate a V₂O₅ product of greater than 99.5% purity.

Each document, reference, patent application or patent cited in this text is expressly incorporated herein in their entirety by reference, which means that it should be read and considered by the reader as part of this text. That the document, reference, patent application, or patent cited in this text is not repeated in this text is merely for reasons of conciseness.

Reference to cited material or information contained in the text should not be understood as a concession that the material or information was part of the common general knowledge or was known in Australia or any other country.

### DISCLOSURE OF THE INVENTION

In accordance with the present invention there is disclosed a method for the recovery of vanadium, the method comprising the steps of:
(i) Subjecting a vanadium-containing ore to a beneficiation step incorporating a sequence of medium-intensity magnetic separation, high-intensity magnetic separation and reverse silica flotation processes to form a vanadium-containing concentrate;
(ii) Roasting the vanadium-containing concentrate;
(iii) Leaching a product of the roasting step (ii) to extract vanadium into a pregnant leach liquor;
(iv) Passing the pregnant leach liquor of leaching step (iii) to a precipitation step; and
(v) Treating a precipitate from step (iv) to obtain a vanadium product, wherein an iron-titanium product from step (iii) is recovered.

Preferably, the purity of the vanadium product is greater than 99%. In one form, the purity of the vanadium product is about 99.5%.

Preferably, the vanadium-containing concentrate of step (i) is subjected to pelletisation before the roasting step.

Preferably, the vanadium-containing concentrate comprises a reduced silica content.

Still preferably, the silica content of the vanadium-containing concentrate is less than about 2.0%.

Preferably, the high purity vanadium product prepared by the method of the present invention is high-purity vanadium pentoxide (V₂O₅).

Preferably, the vanadium-containing ore comprises titanium and iron in addition to the vanadium.

Still preferably, the vanadium-containing ore is a vanadium-containing titanomagnetite ore.

Preferably, the beneficiation step further comprises one or more of primary and secondary grinding, magnetic separation and flotation separation steps.

Still preferably, the silica content in the vanadium-containing ore is reduced using reverse flotation technology.

Still further probably, the reverse flotation of the silica content is achieved with an optimised combination of causticized starch depressant, diamine silica collector, frother and operating pH.

Still preferably, the pelletisation uses a binder, the binder preferably being a carboxyl cellulose organic binder.

Still further preferably, the optimum dose rate of the binder is about 1.5-2.1 kg/dmt concentrate.

Preferably, a salt is added during pelletisation, the salt being sodium chloride, sodium sulphate, sodium hydroxide or sodium carbonate. Still preferably, the salt is sodium carbonate.

Preferably, the roasting step is conducted using a vertical shaft furnace, rotary kiln, straight kiln or grate kiln.

Still preferably, the roasting step in a grate kiln is conducted at a temperature of about 1000-1150° C. in a grate furnace.

Still preferably, the roasting step in a grate kiln is further conducted at a temperature of about 1150-1350° C. in a downstream rotary kiln.

Preferably, the leaching step is conducted at alkaline pH. Still preferably, there is minimal dissolution of titanium, chromium, iron, manganese and other minor impurities in the vanadium-containing ore during the leaching step.

Preferably, the leaching step (iii) further comprises a series of washing and separation steps.

Still preferably, the leaching step (iii) comprises the use of a subsequent nanofiltration step and solvent extraction steps.

In one form of the present invention the leaching step (iii) comprises the following steps:
a. the product of the roasting step (ii) is leached with a mixture of recycled pregnant leach liquor and process water, producing a slurry;
b. the slurry of step a. is dewatered to obtain a pregnant leach liquor and a filter cake, the filter cake being washed and the wash liquor recycled to the leach of step a.;
c. the filter cake of step b. is stacked into one or more heaps and washed to remove soluble metals from the residue;
d. a pregnant leach solution from step b. or the or each heap of step c. is passed to a sequence of nanofiltration and solvent extraction steps to yield a vanadium solution and a barren raffinate; and
e. the barren raffinate of step d. is returned to step a.

Preferably, the product of roasting step (ii) is quenched and ground prior to leaching. The product of roasting step (ii) is preferably quenched and ground in a rotating mill.

Still preferably, the leach of step a. is undertaken in a rotating drum.

Still further preferably, the one or more heaps of step c. are washed in a counter-current manner. The one or more heaps of step c. are preferably finally washed using filtered raw water.

Preferably, the vanadium solution produced in step d. is an ultra-high purity vanadium solution.

In one form of the present invention, the precipitation step (iv) comprises a purification step to remove silicate and an AMV precipitation step to precipitate ammonium metavanadate.

Preferably, ammonium sulphate and sulphuric acid are sequentially added at pH 7.8 during the AMV precipitation. Still preferably, addition of ammonium sulphate is controlled to target a feed solution to AMV precipitation above 200% of the ammonium stoichiometric requirement.

In another form of the present invention, the precipitation step (iv) is an APV precipitation step to precipitate ammonium polyvanadate.

Preferably, ammonium sulphate at pH 2-3 and 80-90° C., and sulphuric acid are used during APV precipitation. Still preferably, the ammonium sulphate is added in excess at 120% above the stochiometric requirement. Still further preferably, the APV precipitate is repulped in acidified ammonium sulphate solution at pH 2-3 and 60-90° C. and dewatered for sodium impurity removal.

Preferably, the AMV or APV precipitate is dried and subjected to ammonia removal at 600-660° C. to form V₂O₅ powder.

Still preferably, the V₂O₅ powder is subject to melting in a shaft furnace and cooling on a flaking wheel to form V₂O₅ flakes for packaging.

Preferably, the iron-titanium product is subject to upgrading by physical separation or a combination of pyrometallurgical and physical separation.

Still preferably, the iron-titanium product is subject to reductive roasting, regrinding and magnetic separation to produce iron-rich by-product and titanium-rich by-product.

### DESCRIPTION OF THE DRAWINGS

The present invention will now be described, by way of example only, with reference to a number of embodiments thereof and the accompanying drawings, in which:

FIG. 1 is a flowsheet depicting a method for the recovery of vanadium from a vanadium-containing ore in accordance with the present invention;

FIG. 2 is a flowsheet depicting a beneficiation step in accordance with one embodiment of the invention shown in FIG. 1;

FIG. 3 is a flowsheet depicting a pelletisation step and a salt roasting step in accordance with one embodiment of the invention shown in FIG. 1;

FIG. 4 is a flowsheet depicting a leach step in accordance with one embodiment of the invention shown in FIG. 1;

FIG. 5 is a flowsheet depicting a vanadium precipitation step in accordance with one embodiment of the invention shown in FIG. 1; and

FIG. 6 is a flowsheet depicting the recovery of titanium and iron containing by-products in accordance with the invention of FIG. 1.

### BEST MODE(S) FOR CARRYING OUT THE INVENTION

The present invention provides a method for the recovery of vanadium, the method comprising the steps of:
(i) Subjecting a vanadium-containing ore to a beneficiation step incorporating a sequence of medium-intensity magnetic separation, high-intensity magnetic separation and reverse silica flotation processes to form a vanadium-containing concentrate;
(ii) Roasting the vanadium-containing concentrate;
(iii) Leaching the product of the roasting step (ii) to extract vanadium into a pregnant leach liquor;
(iv) Passing the pregnant leach liquor of leaching step (iii) to a precipitation step; and
(v) Treating a precipitate from step (iv) to obtain a vanadium product,
   wherein an iron-titanium product from step (iii) is recovered.

In one form the present invention provides a combined physical beneficiation, pyrometallurgical and hydrometallurgical method for preparing high-purity vanadium pentoxide, the method comprising the principal steps of:
(i) Preparing a blended VTM ore feedstock based on geometallurgical and geochemical characteristics;
(ii) Subjecting the blended ore feedstock to a series of physical beneficiation technologies including but not limited to primary and secondary grinding, magnetic, gravity and flotation separation techniques in order to form a uniform VTM concentrate with a limited silicate content;
(iii) Formation of sized pellets of the uniform VTM concentrate feedstock using an appropriate binder;
(iv) Addition of a suitable salt during the uniform VTM concentrate feedstock pellet formation step to facilitate the formation of a soluble vanadium-containing compound in a subsequent roasting step;
(v) Subjecting the pelletised feedstock to a high-temperature roasting step;
(vi) Subjecting the roasted pelletised feedstock (calcine) to an alkali leach step to dissolve the bulk of the vanadium content of the calcine with minimal dissolution of titanium, chromium, iron, manganese and other minor impurities in the original VTM;
(vii) Subjecting the pregnant leach slurry arising from the calcine leach stage to a series of solid/liquid washing and separation steps, including the use of conventional nanofiltration and solvent extraction (SX) technology, to ultimately yield a clarified pregnant leach liquor;
(viii) Precipitating a vanadium-containing product from the purified and clarified pregnant leach liquor;
(ix) Roasting the washed vanadium-containing solid product to yield a high-purity vanadium pentoxide; and
(x) Recovering a solid residue resulting from the calcine leaching and solid/liquid separation stages and subjecting this residue to one or more steps to recover titanium-and iron-containing by-products.

The objectives of the physical beneficiation steps include, but are not limited to, (a) maximising the VTM concentrate grade by removing vanadium-free mineral assemblages and (b) ensuring that the silica content of the recovered concentrate is less than about 2%.

A combination of primary and secondary grinding, magnetic and gravity stages results in the formation of a VTM concentrate.

Silica-containing gangue minerals are removed using reverse flotation technology.

Flotation of the silica-containing gangue minerals is achieved with an optimised combination of causticized starch depressant, diamine silica collector, frother and operating pH, such optimisation being directly related to the mineralogical content of the blended VTM feedstock.

Pellets of the VTM concentrate are formed using a disc or drum pelletiser, the optimum size of which is subject to the characteristics of the roasting technology but is typically about 6 to 16 mm in diameter. A binder is added, for example carboxyl cellulose organic binder such as Peridur 300™ or equivalent, added at an optimum dose rate of about 1.5-2.0 kg/dmt concentrate, to improve green strength. It is to be understood that other binders and/or different addition rates may be applicable, subject to the characteristics of the particular feedstock. Undersize pellets together with reground oversize pellets are returned to the upfront of the pellet formation circuit.

A suitable salt such as sodium chloride, sodium sulphate, sodium hydroxide or sodium carbonate is added to the pellet formation step.

The preferred salt is sodium carbonate in dry form in an amount that is in excess of that required, not restricted to but typically about 3-5% by mass, to convert the vanadium content of the roaster calcine into a water-soluble vanadium salt.

The sized pellets containing sodium carbonate and binder(s) are subjected to drying and a high temperature roasting step in a vertical shaft furnace or rotary kiln or straight kiln or grate kiln system to convert the vanadium content of the pellets into a water-soluble form while minimising the formation of other water-soluble compounds.

The operating temperatures of the grate kiln system, wherein the peak operating temperatures of the travelling grate furnace and the downstream rotary kiln are preferably in the respective ranges of about 1000-1150° C. and about 1150-1350° C.

The product (calcine) of the salt roasting circuit is cooled to a temperature below about 115° C. to 400° C. in an annular or a controlled flow or a rotary cooler before being discharged into a suitable leach circuit.

Cooled calcine pellets may be leached as described below:
(i) Cooled calcine pellets are quenched and lightly comminuted, for example in a SAG mill, a dry cone or roller crush, followed by leaching in a wet rotating drum or equivalent using a mixture of recycled PLS and process water to control the vanadium concentration in the repulp solution;
(ii) Dewatering of the leach slurry from the wet rotating drum, for example on a belt filter, followed by one or more stages of washing on the filter;
(iii) Final washing of the residue in heaps under an ambient environment using filtered raw water to produce a soluble-vanadium free iron-titanium by-product for sale;
(iv) PLS from the heap wash is pumped to an ultra-high purity vanadium circuit, comprising nanofiltration and solvent extraction, to yield a concentrated, solution for generating an ultra-high purity product. SX barren (raffinate) is returned to the primary leaching circuits to maintain the process water balance.
(v) The SX organic phase is typically a quaternary amine, and when loaded is stripped with concentrated ammonia;
(vi) The strip solution enriched with ultra-high purity vanadium advances to the vanadium precipitation circuit; and
(vii) The heap leach residue at the completion of the leach cycle is washed with vanadium free process water to produce an iron-titanium by-product free of soluble vanadium.

The vanadium-containing pregnant liquor solution containing about 20-40 g/L V is transferred to a vanadium precipitation step.

The vanadium-containing PLS is initially purified by desilication for soluble silicate removal. Aluminium sulphate and sulphuric acid are sequentially added where the soluble silicate is precipitated as aluminosilicate at pH about 8.3 and at about 80° C. Aluminium sulphate is added in excess at about 133% above stochiometric requirement.

The purified PLS after desilication is cooled in a heat exchanger to about 35° C.

The purified and cooled PLS is subjected to AMV precipitation. Ammonium sulphate and sulphuric acid are sequentially added, where the vanadium is precipitated as ammonium metavanadate from the purified PLS at pH about 7.8. Addition of ammonium sulphate is controlled to target a feed solution AMV precipitation above 200% of the ammonium stoichiometric requirement.

APV is precipitated directly from the dirty PLS without purification using ammonium sulphate at pH about 2-3 and about 80-90° C. using sulphuric acid as the pH modifier. Addition of ammonium sulphate is controlled to target a feed solution to AMV precipitation above 120% of the ammonium stoichiometric requirement.

The AMV or APV precipitate is dried and subjected to deammoniation for ammonia removal at about 600-660° C. to form V₂O₅ powder.

The V₂O₅ powder is melted in a shaft furnace at about 800° C. and the molten V₂O₅ is cooled on a flaking wheel to form V₂O₅ flakes and packaged as may be required.

The soluble vanadium-free calcine is subjected to further upgrading for the production of discrete marketable iron and titanium-containing by products, either by physical separation or combination of pyrometallurgical and physical separation.

The soluble vanadium-free calcine is subjected to a reductive roast using a carbon rich additive, carbon monoxide or hydrogen at about 800-1200° C. to convert hematite into magnetite or metallic iron.

The reductive roast calcine is lightly comminuted, for example in a SAG mill or a dry cone or roller crush, in closed circuit with cyclones to yield a target grind size P80 of about 20-75 μm for liberating magnetite or metallic iron from titanium gangue.

The ground reduced product is subjected to magnetic separation at about 300 to 900 G for separation of magnetite or metallic iron enriched concentrate from titanium enriched non-magnetic product.

The titanium enriched non-magnetic product may be further upgraded by physical beneficiation such as gravity separation or flotation.

The titanium enriched non-magnetic product may be further upgraded by a hydrometallurgical processing route.

The present invention is, at a high level, generally concerned with the recovery of a high-purity vanadium pentoxide product from a run-of-mine VTM resource using what might be described as an updated or enhanced version of the prior art “salt-roast process”. This approach has been determined by the Applicants to be a preferred method to recover vanadium pentoxide when compared with direct selective pyrometallurgical or direct selective hydrometallurgical processes.

The method of the present invention comprises, in one form, the following major processing stages:

STEP 1: Physical beneficiation of blended run-of-mine ore.

STEP 2: Roasting of an upgraded concentrate.

STEP 3: Leaching roasted product, with subsequent nanofiltration and solvent extraction to assure maximum vanadium recovery, improve final product purity, and remove any soluble metals from the by-product streams.

STEP 4: Recovery of a high-grade vanadium-containing solid ahead of conversion to the desired vanadium pentoxide product.

STEP 5: Production of an iron-titanium product from STEP 3.

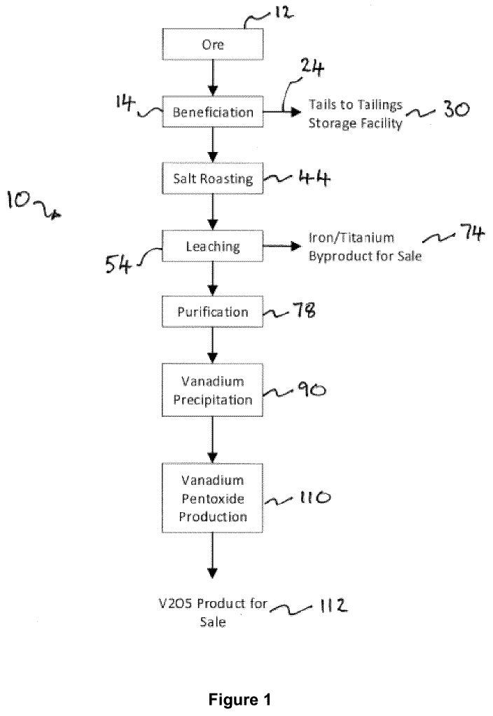

In FIGS. 1 to 6 there is shown a method for the recovery of vanadium from vanadium bearing ores or concentrates 10 in accordance with the present invention.

More specific details and examples of the above processing stages are outlined below. The scope of the present invention covers the processing of VTM run-of-mine ores in general and is not limited to the mineralogical characteristics of the feedstock described and tested as indicative samples.

### Step 1—Beneficiation

Development and application of the present invention is based on a typical resource that geometallurgical evaluation indicates has three major ore zones-upper oxidised, transition, and lower fresh (primary) VTM ore. Development of a flowsheet for the physical beneficiation of a continuous and sustainable blended run-of-mine feedstock included testing of various combinations of samples from each of the three main resource horizons.

The major mineral content of the blended run-of-mine VTM ore typically consists of magnetite, maghemite, hematite, ilmenite, goethite, sheet silicates, free silica (quartz) and a range of minor gangue minerals. Typically, each mineral is not present as a single, discrete phase, but is present as composites of various variable phases. For example, vanadium-bearing mineral grains such as magnetite may be intergrown with ilmenite or hematite or various sheet silicates. To beneficiate such an ore with a complex mineral texture often requires a combination of physical beneficiation techniques to assure acceptable vanadium recovery and gangue rejection. Excess gangue has negative impacts on downstream processes.

Silicate content in the roaster feedstock competes with the vanadium for the sodium flux, requiring more reagent and lowering vanadium recovery as silica content increases.

Preparation of the roaster feedstock involves a blended run-of-mine ore 12 being first subjected to beneficiation 14, including crushing 16 and milling 18, for example an AG or SAG mill, to a typical P80 of between about 106 and 350 μm, sequential medium intensity (MIMS) and high intensity magnetic separation (HIMS) to form a magnetic fraction 20 and 22, and a non-magnetic fraction 24. For example, rougher MIMS 26 and scavenger wet high intensity magnetic separation (WHIMS) 28 are employed. The non-magnetic fraction 24 from WHIMS is discharged ultimately to a tailings storage facility 30. The magnetic concentrates recovered from MIMS and WHIMS are recombined and reground 32 in a ball, tower or other mill to a typical P80 between about 53 and 106 μm and forwarded to a flotation circuit 34. Actual grind size is determined by factors such as crystal size of the vanadium bearing minerals and the liberation of gangue minerals such as silicates/silica.

In operations of the prior art, the silicate content reporting to the concentrate is managed using a low or medium intensity magnetic separation. The Applicant believes however that this results in a loss to the tailings of vanadium hosted by weakly magnetic minerals. The method of the present invention incorporates the use high intensity magnetic separation to recover vanadium from weakly-magnetic host minerals, and reverse silica flotation to control the level of silicate in the final concentrate. In a preferred form silicates are floated and discharged as a silicate-rich froth to a tailings storage facility, with iron-bearing minerals reporting to the iron sinks.

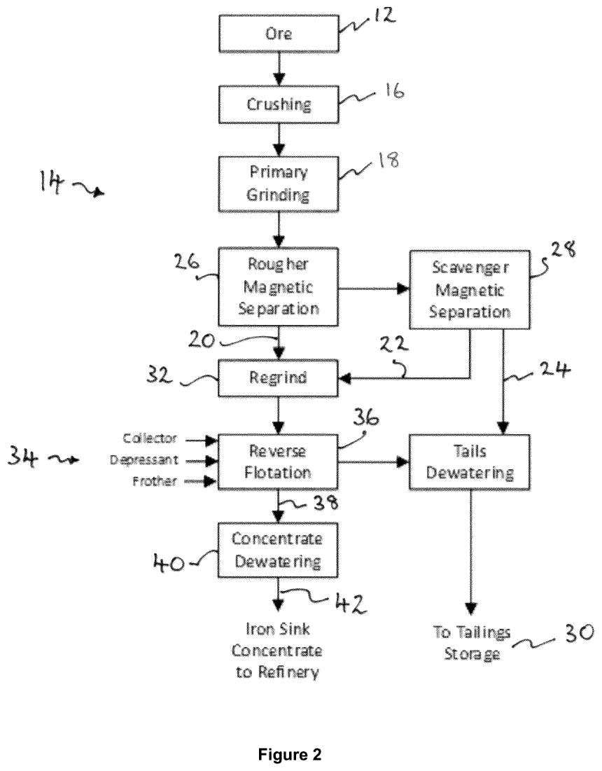

FIG. 2 describes an example of a physical beneficiation employed in one embodiment of the present invention.

The combined use of crushing 14, primary grinding 16, two stages of magnetic separation 26 and 28, intermediate re-grinding 32, followed by silicate removal in the flotation circuit 34, for example using reverse flotation 36 constitutes one aspect of the present invention. As noted above, it is to be understood that some variation of the actual operating parameters to match the geometallurgical characteristics of the blended run-of-mine ore 12 may be expected without departing from the spirit or scope of the present invention.

Detailed laboratory and pilot scale tests of the reverse flotation circuit using the batch and continuous modes of operation resulted in the development of the following preferred but not mandatory processing criteria:
Causticized starch depressant at 400-800 g/t feed
Diamine silica collector at 150-200 g/t feed
Frother at 0-10 g/t feed
pH 8-9

The physical beneficiation circuit of the present invention targeted the production of an iron sink concentrate containing less than 2.0% silica in a roaster feed. Examples for the physical beneficiation test performance are detailed in Table 1 below.

TABLE 1
Physical beneficiation of Samples 1 and 2
Sample 1

| | V₂O₅ | Fe | TiO₂ | SiO₂ | MgO | Al₂O₃ | Cr |
|---|---|---|---|---|---|---|---|
| Stream | (%) | (%) | (%) | (%) | (%) | (%) | (%) |
| Head | 1.13 | 44.7 | 13.2 | 8.66 | 1.65 | 6.73 | 0.45 |
| MIMS Concentrate | 1.40 | 54.0 | 14.6 | 1.58 | 0.60 | 2.94 | 0.57 |
| Recovery to MIMS | 51.2 | 48.8 | 43.3 | 7.5 | 15.3 | 18.1 | 50.7 |
| WHIMS Concentrate | 1.18 | 46.5 | 14.3 | 6.50 | 1.52 | 5.64 | 0.44 |
| Float feed | 1.31 | 50.9 | 14.5 | 3.61 | 0.98 | 4.05 | 0.52 |
| Iron Sink | 1.39 | 53.3 | 14.9 | 1.83 | 0.60 | 2.81 | 0.53 |
| Concentrate | | | | | | | |
| Recovery to Iron | 69.2 | 67.1 | 63.7 | 11.9 | 20.5 | 23.5 | 66.3 |
| Sink Concentrate | | | | | | | |

Sample 2

| | V₂O₅ | Fe | TiO₂ | SiO₂ | MgO | Al₂O₃ | Cr |
|---|---|---|---|---|---|---|---|
| Stream | (%) | (%) | (%) | (%) | (%) | (%) | (%) |
| Head | 1.12 | 45.8 | 12.9 | 8.13 | 2.35 | 6.55 | 0.43 |
| MIMS Concentrate | 1.36 | 55.1 | 14.2 | 1.51 | 0.88 | 2.90 | 0.53 |
| Recovery to MIMS | 68.4 | 66.8 | 60.7 | 10.4 | 21.1 | 24.8 | 69.7 |
| WHIMS Concentrate | 1.05 | 42.5 | 13.7 | 9.14 | 3.05 | 7.02 | 0.37 |
| Float feed | 1.26 | 51.2 | 14.0 | 3.87 | 1.55 | 4.17 | 0.48 |
| Iron Sink | 1.37 | 54.5 | 14.5 | 1.74 | 0.81 | 2.74 | 0.51 |
| Concentrate | | | | | | | |
| Recovery to Iron | 76.0 | 74.2 | 70.2 | 13.4 | 21.6 | 26.1 | 74.5 |
| Sink Concentrate | | | | | | | |

It can be seen that the specific combination or sequence of MIMS, WHIMS and reverse flotation delivers a higher vanadium recovery than the use of MIMS alone. This is consistent with the objective of the present invention in recovering weakly magnetic vanadium bearing minerals whilst also maintaining a silica concentration of less than 2%. Similar results were obtained by the Applicant with blends of other combinations of samples representing the three geometallurgical zones within the overall VTM resource.

### Step 2—Pelletising and Roasting

A physically beneficiated vanadium-containing concentrate 38 is washed and dewatered 40, forming an iron sink concentrate 42 that is forwarded to the salt roasting stage 44. It is envisaged that this could be milled, blended with the appropriate salt additive, and used as the feedstock for a fluid bed roaster, shaft furnace, rotary kiln, or grate kiln.

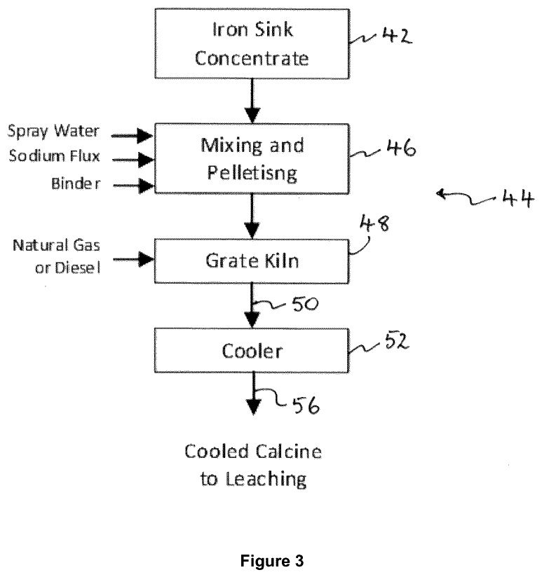

FIG. 3 shows an example of pelletising and salt roasting of pellets in a grate kiln system in accordance with the present invention.

The concentrate 42 is pelletised 46 prior to roasting 44 and this has been found by the Applicants to result in better overall vanadium extraction when compared with roasting a ground concentrate. The use of a pelletised feedstock in this manner has been found to be more economic by the Applicants. For this type of feedstock, vertical shaft, rotary kiln, travelling grate (straight grate) or grate kiln firing systems can be employed. It is understood by the Applicants that pellets for the roast employed in the present invention advantageously do not require the same physical strength as a blast furnace feed.

A grate kiln 48 has been determined by the Applicants to be the preferred option for the roasting step 44 of the present invention. This technology delivers superior vanadium extraction with less abrasion and fewer other factors that result in the generation of excessive fines. Unlike a shaft furnace, it can produce a more uniform fired pellet from a variety of feedstocks, such as magnetite and hematite.

The grate kiln 48 consists of three separate process units connected in series:
A travelling grate for drying, preheating and induration of green pellets, and oxidation of magnetite to hematite.
A rotary kiln for salt roasting of preheated pellets to convert vanadium bearing minerals to water soluble sodium metavanadate.
A cooler for cooling the fired pellets.

The general avoidance of the generation of excessive fines and kiln ringing are advantageous features of the present invention. Another advantageous feature of the grate kiln 48 is that it uses the hot recuperated air for drying and heating, minimising thereby fuel consumption.

The Applicants have determined that the pelletised feedstock should ideally have a hard-outer surface (skin) that is abrasion resistant with the ability to survive the rotational forces of a rotary kiln. The skin and core should have a high degree of porosity to facilitate mass transfer of the vanadium content during leaching of the roasted product.

As noted previously, various salts can be used to facilitate the formation of water-soluble vanadium in the roasted product. In terms of cost and effectiveness, sodium chloride, sodium sulphate and sodium carbonate are the potential salt additives. More particularly the preferred option for the present invention is sodium carbonate. The generation/evolution of carbon dioxide as the roaster temperature facilitates the required pellet porosity. Increased pellet porosity may be attributed, in part to the conversion of magnetite during the roasting (oxidation) reactions. The sodium chloride and sodium sulphate additives are effective but their use involves the generation of environmentally undesirable roaster off-gases, requiring additional capital and operating costs. In addition, chloride and sulphate report to the pregnant vanadium-containing leach liquor introducing additional challenges with process water quality and balance.

Pelletising 46 may be undertaken using, for example, a disc or drum pelletiser. The size of pellets is partly a function for the design and operation of the roaster furnace, but will typically have a diameter of about 6-16 mm. The required salt reagent and suitable binder are added in the dry form during pellet formation. Water is added with a suitable binder, either organic or inorganic, as needed to assure green strength and preheated and fired pellet strengths are achieved. Good mixing is required to ensure that there is uniform distribution of the salt and binder throughout the matrix of each pellet. The salt reagent addition rate is in excess of the stoichiometric requirement to convert the vanadium in the roaster feedstock to the water-soluble vanadate form, and typically corresponds to about 3-5% by weight of the pelletised feedstock, governed by the contents of vanadium and other salt consuming impurities. Oversize pellets can be reground, and along with undersize pellets, returned to the front end of the pellet preparation circuit.

The travelling grate consists of four main zones including updraft drying (UDD), downdraft drying (DDD), tempered preheating (TPH) and preheating (PRE). Numerous pilot scale tests demonstrated that UDD followed by DDD provides an even heat distribution, preventing the pellets from cracking and/or collapsing during drying. In the TPH and PRE zones, the temperature is ramped up to between about 1000-1150° C. for pellet induration to generate preheated pellets that can survive the rotational force in the rotary kiln. Oxidation of magnetite to hematite also occurs in the PRE zone, resulting in the induration of the green pellets. In this zone, the vanadium also begins to oxidise and react with the salt, prior to roasting in the rotary kiln.

The indurated pellets are then transferred to a rotary kiln, and the temperature is ramped up to a peak of between about 1150-1350° C., where the vanadium continues to react with sodium to complete effective conversion into soluble sodium metavanadate. The product 50 is then cooled in an annular, controlled or rotary cooler 52 before being directed to a vanadium leach circuit 54. The temperature of a final pellet 56 is dependent on the overall design of the leach circuit but will typically be between about 115-400° C.

Batch pelletising tests found that an inorganic binder such as bentonite was ineffective to improve pellet strength. However, it was demonstrated that pellet strength was sufficient without additives or further processing. Green strength was shown to be an important factor in operation of the grate kiln. To avoid pellet degradation, a suitable binder is required. Test work has indicated that the addition of an organic binder such as carboxymethyl cellulose into the pellet blend sufficiently improves green pellet strength. Testing indicates that a drop number, as understood with standard iron ore pellet characterisation, of 4-5 is preferred to avoid pellet breakage early in the induration process.

Batch tests also demonstrated that the controlling of pellet moisture during pelletising was paramount to promote agglomeration in achieving target green pellet strength. The Applicants have found that the optimum pellet moisture was about 11-12% w/w.

Various batch tests conducted by firing the green pellets in a pilot scale grate kiln rig under various commercial grate kiln heat profiles, have successfully converted more than 90% of vanadium in the roaster feed into a water-soluble sodium metavanadate. The conversion was affected by sodium flux rate, binder type and dose rate, travelling grate bed depth, transition temperature and hot zone retention time. Examples of the test conditions and the corresponding vanadium conversion are shown in Table 2.

TABLE 2
Pilot pyrometallurgical tests

| Bed | Soda Ash | Peak Temperature (° C.) | | Hot Zone | Vanadium |
|---|---|---|---|---|---|
| depth | Dose Rate | | Rotary | Retention | Conversion |
| (mm) | (% w/w) | Grate | Kiln | Time (min) | (%) |
| 152 | 4.0 | 1150 | 1315 | 12.6 | 93.4 |
| 157 | 4.0 | 1150 | 1310 | 16.3 | 91.3 |
| 229 | 4.0 | 1150 | 1315 | 12.6 | 91.6 |
| 152 | 4.0 | 1100 | 1315 | 12.6 | 91.5 |
| 155 | 4.5 | 1100 | 1315 | 12.6 | 92.9 |
| 152 | 4.5 | 1100 | 1324 | 12.6 | 92.2 |
| 229 | 4.0 | 1100 | 1315 | 12.6 | 92.0 |
| 152 | 4.0 | 1100 | 1300 | 12.6 | 93.0 |
| 150 | 4.0 | 1115 | 1319 | 21.0 | 92.9 |

### Step 3—Leaching

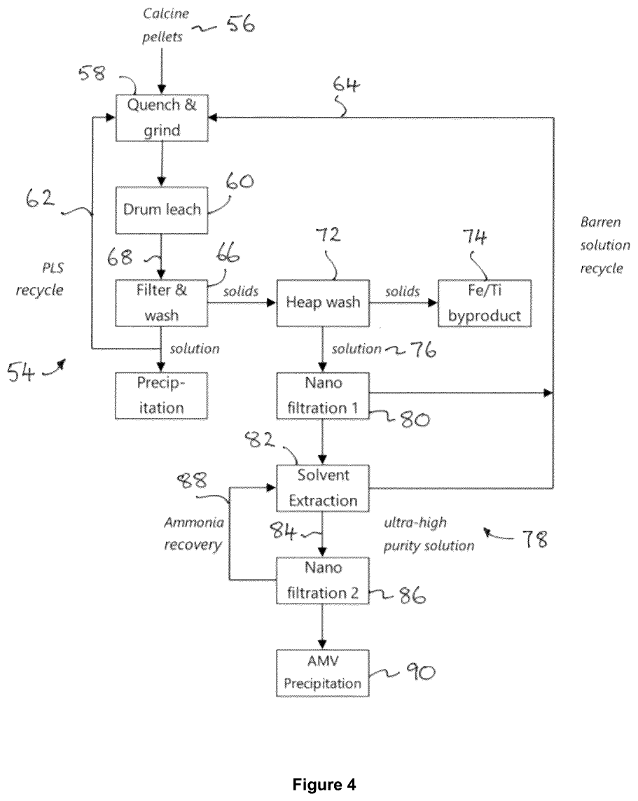

Detailed test work and operating parameters using roaster calcine led to the development of the following leach step, as shown in FIG. 4.

This example of the present invention utilises a two-stage leach process to promote vanadium leach kinetics, while minimising the overall water requirements for the system. Leach kinetics are partially driven by vanadium concentration in the leach solution, therefore this example of the present invention seeks to minimise water usage while maximising overall leach extraction.

Stage 1 involves the recovery of soluble vanadium from vanadium-bearing minerals. Stage 2 is effectively a wash that removes traces of soluble vanadium and other metals from the stage 1 residue. In a preferred form it utilises counter-current washing to improve the leach kinetics for maximising the recovery of soluble vanadium. In each case, the target vanadium leach circuit recovery is greater than about 91% while achieving a soluble vanadium content appropriate for the efficient precipitation of AMV or APV, and maintaining an overall process water balance by minimisation of raw water consumption.

As noted hereinabove, one aspect of the present invention is the recovery of the bulk of the leached vanadium-free roaster product as a marketable iron oxide-titanium oxide material suitable for use in steel production or in other specialised markets. This factor is taken into account in assessing the overall viability of each leaching option described hereinbelow.

Cooled calcine pellets 56 are quenched and lightly comminuted or ground 58, for example in a SAG mill, a dry cone or roller crush, followed by leaching 60 in a wet rotating drum or equivalent using a mixture of recycled PLS 62 and process water/SX raffinate 64 to control the vanadium concentration in the repulp solution. Dewatering 66 of a leach slurry 68 from the wet rotating drum, for example on a belt filter, is followed by one or more stages of washing on the filter.

A pellet residue or cake 70 is stacked in heaps and washed 72 under ambient conditions using process water in a counter-current manner to produce an iron-titanium by-product 74 for sale that is free of soluble vanadium.

A PLS 76 from the heap wash 72 is pumped to an ultra-high purity vanadium circuit 78, comprising nanofiltration 80 and solvent extraction 82, to yield a concentrated solution for generating an ultra-high purity product. The SX barren (raffinate) 64 is returned to the primary leaching circuits to maintain the process water balance.

The SX organic phase is typically a quaternary amine, and when loaded is stripped with concentrated ammonia. A strip solution 84 is passed through a second nanofiltration unit 86 to recover and recycle ammonia 88. The strip solution 84 enriched with ultra-high purity vanadium advances to a vanadium precipitation circuit 90.

The heap leach residue at the completion of the leach cycle is washed with vanadium-free process water to produce the soluble vanadium-free iron-titanium by-product 74.

A pilot scale leach study was conducted using 460 kg of roasted concentrate fed to a 74 litre drum heated to 90° C. over a 10 hour period. The drum internal diameter was 336 mm, with a discharge diameter of 308 mm and a rotational speed of 5-10 rpm. The pellets were crushed from a starting size of −16 mm+12.5 mm to minus 6.3 mm. Drum discharge was filtered and washed using a three-stage counter current batch process. The residue grades and overall recoveries were monitored and are summarised in Table 3 below.

TABLE 3
Residue Grades and Overall Recoveries

| Processing | Head | Final Filter Cake | V Extraction |
|---|---|---|---|
| time (h) | V (%) | V grade (%) | (%) |
| 1 | 0.76 | 0.100 | 86.8 |
| 2 | 0.76 | 0.095 | 87.5 |
| 3 | 0.76 | 0.089 | 88.3 |
| 4 | 0.76 | 0.097 | 87.2 |
| 5 | 0.76 | 0.095 | 87.5 |
| 6 | 0.76 | 0.100 | 86.8 |
| 7 | 0.76 | 0.100 | 86.8 |
| 8 | 0.76 | 0.110 | 85.5 |
| 9 | 0.72 | 0.097 | 86.5 |
| 10 | 0.72 | 0.110 | 84.7 |

The filtered and washed residue from the drum leach was placed in a series of 1 m columns with an internal diameter of 100 mm. Tap water was run through the first column at approximately 6 to 10 L/min/m², with the discharge feeding the second. The discharge from the second column fed the third, and the arrangement continued for subsequent columns. Columns of washed ore were removed from the start of the process and columns of fresh material added to the end to achieve a steady state. At steady state, the vanadium solution tenor for the input and output streams over six stages are shown in FIG. 7.

This process extracted a further 3% vanadium with six stages of washing, in addition to the average of 88% in the drum leach. This resulted in a total of 91% vanadium extraction for the drum/heap leach system.

### Step 4—Precipitation

Vanadium is recovered from pregnant liquor solutions either as ammonium metavanadate (AMV) or ammonium polyvanadate (APV) precipitate with the addition of ammonium sulfate.

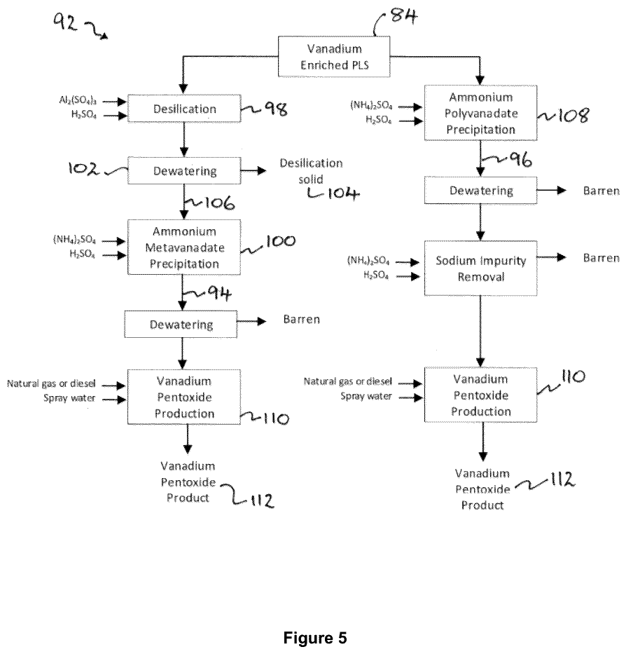

A process flowsheet 92 for vanadium precipitation as employed in the method of the present invention is shown in FIG. 5, showing how vanadium may be recovered from a pregnant liquor solution as either ammonium metavanadate (AMV) precipitate 94 or ammonium polyvanadate (APV) precipitate 96 with the addition of ammonium sulfate.

The AMV process requires a desilication step 98 for purification prior to AMV precipitation 100. The presence of soluble silicate interferes with AMV precipitation. Without desilication, vanadium co-precipitates with soluble silicate to form gel-like precipitates that are difficult to filter. Aluminium sulphate and sulphuric acid are sequentially added to the clean PLS, where the soluble silicate is precipitated as sodium alumino-silicates. The desilication step 98 is conducted, for example, at pH 8.3 and 80° C. Aluminium sulphate is provided above the stochiometric requirement, as supported by bench-scale testwork. The sodium alumino-silicate precipitates are removed by filtration 102, where a purified PLS advances to the AMV precipitation circuit 100. A filter cake is disposed as a sodium alumino-silicate solid 104. Alternatively, the slurry may be thickened, with overflow proceeding to AMV precipitation and the silicate containing underflow proceeding back to the leach circuit.

A clean pregnant liquor 106 is cooled through a heat exchanger to target temperature of 35° C. Ammonium sulphate and sulphuric acid are sequentially added to precipitate vanadium as AMV. Ammonium sulphate is added in excess of the stochiometric requirement, typically greater than about 200%, as indicated in bench-scale test work.

Vanadium can be precipitated as APV directly from a dirty PLS. Sulphuric acid is added to bring the solution pH to a target of 2-3. Ammonium sulphate is added in excess of the stochiometric requirement, typically at 120%. The dirty PLS is heated to a minimum temperature of 80° C. for APV precipitation 108.

The AMV or APV precipitates are subjected to calcination 110 at about 600-660° C. for conversion to V₂O₅ powder 112. The V₂O₅ powder 112 can be subjected to further heat treatment at about 800° C. to form molten vanadium, where upon contact with cooling water in the flaking wheel, it forms V₂O₅ flakes.

The V₂O₅ powder generated from calcination of AMV or APV precipitates at 650° C., yielded a product purity of 99.6% under optimised conditions, as shown in Table 4 below.

TABLE 4
Product Quality of Vanadium Pentoxide Powder (%)

| | V₂O₅ | Fe | Cu | Zn | Pb | Cr | Si | Mg | Al | K | Na |
|---|---|---|---|---|---|---|---|---|---|---|---|
| Sample 1 | 99.25 | 0.000 | 0.001 | 0.001 | 0.002 | 0.033 | 0.001 | 0.000 | 0.207 | 0.002 | 0.070 |
| Sample 2 | 99.60 | 0.020 | 0.003 | 0.001 | 0.004 | 0.036 | 0.000 | 0.000 | 0.133 | 0.000 | 0.020 |
| Sample 3 | 99.60 | 0.000 | 0.004 | ≤0.001 | 0.002 | 0.039 | 0.000 | 0.000 | 0.157 | 0.000 | 0.020 |

### Step 5—Iron/Titanium Co-Product

The soluble vanadium free iron-titanium by-product 74 can be marketed “as is” or may undergo further treatment to improve the product value. Such processes include but are not limited to:
Physical beneficiation such as flotation, desliming and gravity separation;
Pyrometallurgical processing such as reductive roasting to convert hematite into magnetite or metallic iron followed by regrind and physical beneficiation, such as magnetic separation, to separate iron rich and titanium by-products; and/or. The titanium by-product can be further upgraded via flotation or gravity separation or a hydrometallurgical processing route.

Bench-scale tests have confirmed conversion of hematite into magnetite or metallic iron when roasting under a reductive environment, for example using a suitable reductant such as coal. The degree of metallisation varying with the reductive roast temperature and reductant flux rate. Other suitable reductants include alternative carbon rich materials, carbon monoxide and hydrogen.

Bench-scale tests demonstrated that the metallic iron can be separated from the titanium gangue via regrinding followed by magnetic separation. The conversion of hematite to metallic iron covered by the present invention was confirmed by the mineralogical investigation, as shown in Table 5 below.

TABLE 5
Mineralogical analysis of reductive roast feed and discharge

| | Mass % | |
|---|---|---|
| | Reductive Roast | Reductive Roast |
| Mineral or mineral group | Feed | Discharge |
| Hematite (partially Ti-bearing) | 71 | 5 |
| Magnetite | 1 | 10 |
| Pseudobrookite | 24 | 7 |
| Freudenbergite | 3 | 2 |
| Nepheline | 1 | 4 |
| Sodium Iron Titanium oxide | 1 | 0 |
| (Na_{0.9}Fe_{0.9}Ti_{1.1}O₄) | | |
| Elemental iron (+/−substitution) | 0 | 69 |
| Cohenite (Fe₃C) | 0 | 4 |

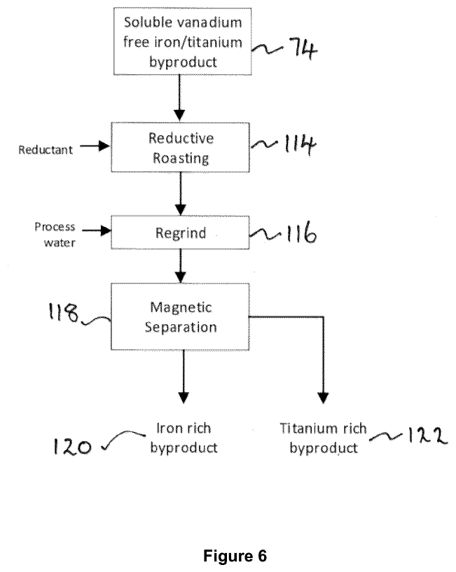

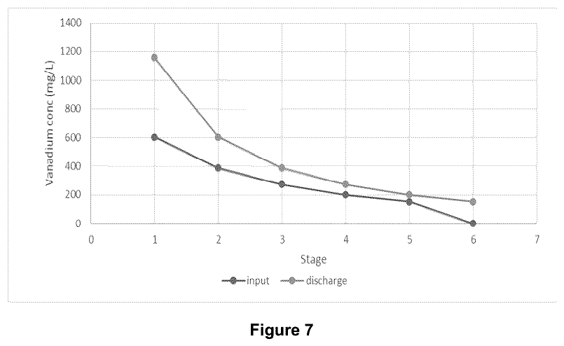

An example of the reductive roast followed by physical beneficiation flowsheet is shown in FIG. 6. A reductive roast 114 is used to convert hematite into magnetite or metallic iron followed by a regrind 116 and physical beneficiation, such as magnetic separation 118, to separate an iron rich by-product 120 and a titanium by-product 122.

As can be seen with reference to the above description, the present invention relates to a method for preparing a high-purity vanadium pentoxide, preparing a marketable titanium-containing iron oxide by-product or individual marketable titanium-and iron-containing by-products, and disposal of undesirable impurities from a vanadium-containing titanomagnetite (VTM) run-of-mine ore in a cost and environmentally sustainable manner. The invention comprises a combination of individual physical beneficiation steps, pyrometallurgical steps and hydrometallurgical steps that are intended to meet the specific objectives noted above.

Modifications and variations such as would be apparent to the skilled addressee are considered to fall within the scope of the present invention.

1.-34. (canceled)

35. A method for the recovery of vanadium, the method comprising the steps of:
(i) subjecting a vanadium-containing ore to a beneficiation step incorporating a sequence of medium-intensity magnetic separation, high-intensity magnetic separation and reverse silica flotation processes to form a vanadium-containing concentrate;
(ii) roasting the vanadium-containing concentrate;
(iii) leaching a product of the roasting step (ii) to extract vanadium into a pregnant leach liquor;
(iv) passing the pregnant leach liquor of leaching step (iii) to a precipitation step; and
(v) treating a precipitate from step (iv) to obtain a vanadium product, wherein an iron-titanium product from step (iii) is recovered.

36. The method of claim 35, wherein the purity of the vanadium product is:
a. greater than 99%; or
b. greater than about 99.5%.

37. The method of claim 35, wherein the vanadium-containing concentrate of step (i) is subjected to pelletisation before the roasting step.

38. The method of claim 35, wherein the vanadium-containing concentrate of step (i) comprises:
a. a reduced silica content; or
b. a silica content of less than about 2.0%.

39. The method of claim 35, wherein the high purity vanadium product prepared by the method of the present invention is high-purity vanadium pentoxide (V₂O₅).

40. The method of claim 35, wherein the vanadium-containing ore:
a. comprises titanium and iron in addition to the vanadium; or
b. is a vanadium-containing titanomagnetite ore.

41. The method of claim 35, wherein the reverse flotation of the silica content is achieved with an optimised combination of causticized starch depressant, diamine silica collector, frother and operating pH.

42. The method of claim 37, wherein the pelletisation uses:
a. a binder;
b. a carboxyl cellulose organic binder; or
c. a binder at a dose rate of about 1.5-2.1 kg/dmt concentrate.

43. The method of claim 37, wherein a salt is added during pelletisation, the salt being:
a. sodium chloride, sodium sulphate, sodium hydroxide or sodium carbonate; or
b. sodium carbonate.

44. The method of claim 35, wherein the roasting step is conducted:
a. in a grate kiln;
b. at about 1000-1150° C. in a grate furnace; or
c. at about 1150-1350° C. in a rotary kiln.

45. The method of claim 35, wherein the leaching step is conducted at alkaline pH.

46. The method of claim 35, wherein the leaching step (iii) comprises the following steps:
a. the product of the roasting step (ii) is leached with a mixture of recycled pregnant leach liquor and process water, producing a slurry;
b. the slurry of step a. is dewatered to obtain a pregnant leach liquor and a filter cake, the filter cake being washed and the wash liquor recycled to the leach of step a.;
c. the filter cake of step b. is stacked into one or more heaps and washed to remove soluble metals from the residue;
d. a pregnant leach solution from the leach of step a. or the or each heap of step c. is passed to a sequence of nanofiltration and solvent extraction steps to yield a vanadium solution and a barren raffinate; and
e. the barren raffinate of step d. is returned to step a.

47. The method of claim 46, wherein the product of roasting step (ii) is:
a. quenched and lightly comminuted prior to leaching; or
b. quenched and ground in a rotating mill.

48. The method of claim 46, wherein the leach of step a. is undertaken in a rotating drum.

49. The method of claim 46, wherein the one or more heaps of step c. are:
a. washed in a counter-current manner; or
b. washed in a counter-current manner using filtered raw water.

50. The method of claim 47, wherein the vanadium solution produced in step d. is an ultra-high purity vanadium solution.

51. The method of claim 35, wherein the precipitation step (iv) comprises:
a. a purification step to remove silicate and an AMV precipitation step to precipitate ammonium metavanadate; or
b. an APV precipitation to precipitate ammonium polyvanadate.

52. The method of claim 51, wherein ammonium sulphate and sulphuric acid are:
a. sequentially added at pH 7.8 during the AMV precipitation;
b. sequentially added at pH 7.8 during the AMV precipitation, with the ammonium sulphate being added in excess at a minimum of 200% above the stochiometric requirement;
c. used during APV precipitation, the ammonium sulphate being at pH 2-3 and 80-90° C.; or
d. used during APV precipitation, the ammonium sulphate being at pH 2-3, at 80-90° C., and in excess at 120% above the stochiometric requirement.

53. The method of claim 51, wherein the APV precipitate is repulped in acidified ammonium sulphate solution at pH 2-3 and 60-90° C. and dewatered for sodium impurity removal.

54. The method of claim 35, wherein an AMV or APV precipitate formed in the precipitation step (iv) is dried and subjected to ammonia removal at 600-660° C. to form V₂O₅ powder.

55. The method of claim 35, wherein the iron-titanium product is subject to reductive roasting, regrinding and magnetic separation to produce iron-rich by-product and titanium-rich by-product.
